(19) United States
(12) Patent Application Publication
(10) Pub. No.: US 2025/0288927 A1
(43) Pub. Date: Sep. 18, 2025

(54) FILTER ELEMENT, ION EXCHANGER FILTER ELEMENT, AND FILTER SYSTEM

(71) Applicant: MANN+HUMMEL GmbH, Ludwigsburg (DE)

(72) Inventors: Klaus MACK, Hardthausen (DE); Maximilian BAUCH, Bönnigheim (DE); Jonas EBLE, Erlenbach (DE); Günter JOKSCHAS, Murrhardt (DE); Pius TRAUTMANN, Stuttgart (DE); Sven WEIDINGER, Weinstadt (DE)

(21) Appl. No.: 19/068,310

(22) Filed: Mar. 3, 2025

(30) Foreign Application Priority Data
Mar. 18, 2024 (DE) 102024107682.8

(51) Int. Cl. B01D 35/30

(52) U.S. Cl. CPC B01D 35/30; B01D 2201/4092

(57) ABSTRACT

A filter element for installation in a housing of a filter system with at least a first housing part and a second housing part is provided with a filter medium body, which has at one end face an end disc, and further provided with a connection device for fixation of the filter element in the housing and for closing the housing. The connection device has at least a first connection element for interaction with the first housing part and at least a second connection element for interaction with the second housing part. The first connection element and the second connection element are arranged at a circumferentially extending rim element which is connected to the end disc and is axially spaced apart from the end disc. A filter system is provided with such a filter element. An ion exchanger filter medium may be provided in the filter element.

### CROSS-REFERENCE TO RELATED APPLICATIONS

This application claims the benefit of German Application No. 10 2024 107 682.8 filed on Mar. 18, 2024, the entire content of which is incorporated herein by reference.

### BACKGROUND

The invention concerns a filter element for a fluid, for example, for a liquid, for example, oil or fuel or coolant, as well as an ion exchanger filter element and a filter system for a fluid, for example, for a liquid, for example, oil or fuel or coolant.

Filter elements with adapter rings with inner and/or outer threads for mounting in a filter housing and/or in a housing cover are known.

US 2016/0097474 A1 discloses a fluid connection component group which includes an outer fastening element and an inner fastening element. The outer fastening element has a top side, a bottom side, and a plurality of radially extending elements at the top side. The inner fastening element has a top side, a bottom side, and a plurality of radially extending projections. The radially extending projections are dimensioned such that they are accommodated in the radially extending elements when the inner fastening element is mounted at the outer fastening element. A connector is arranged in the inner fastening element. The connector is provided with an outer thread so that it accommodates a fluid supply line with inner thread.

Furthermore, filter elements with integrated threads for mounting in a filter housing and/or in a housing cover are known.

In WO 2008/015100 A1, a filter element with filter bellows is described which is covered at the end faces by an end disc, respectively. The end discs each are provided with at least one coupling element for coupling to a filter housing and are connected to each other by at least one central pipe spanning the filter bellows. As an alternative, a continuous central pipe is provided onto which the end discs and the filter bellows are pushed and which, at its end face projections, is embodied to couple to housing parts.

### SUMMARY

It is an object of the invention to provide a filter element for a fluid, for example, for a liquid, for example, oil or fuel or coolant, which may be easily mounted.

A further object of the invention is to provide an ion exchanger filter element with such a filter element.

A further object of the invention is to provide a filter system for a fluid, for example, for a liquid, for example, oil or fuel or coolant, with such a filter element.

The aforementioned object is solved according to an aspect of the invention by a filter element for a fluid, for example, for a liquid, for example, oil or fuel or coolant, for installation in a housing of a filter system with at least a first housing part and a second housing part, the filter element at least comprising a filter medium body, which comprises at least at a first end face a first end disc, and a connection device for fixation of the filter element in the housing as well as for closing the housing, wherein the connection device comprises at least a first connection element for interaction with the first housing part and at least a second connection element for interaction with the second housing part, wherein the first and second connection elements are arranged at a circumferential rim element which is connected to the first end disc and which is axially spaced apart from the first end disc.

The further object is solved according to a further aspect of the invention by an ion exchanger filter element with such a filter element, wherein a filter medium body of the filter element is configured as an ion exchanger.

The further object is solved according to another aspect of the invention by a filter system for a fluid, for example, for a liquid, for example, oil or fuel or coolant, with a housing, comprising a first fluid connector and a second fluid connector, and a filter element arranged in the housing, wherein the housing comprises at least a first housing part and a second housing part, which in the direction of a longitudinal axis are sequentially arranged and are connected to each other, wherein the filter element comprises a filter medium body, which comprises at least at a first end face a first end disc, and a connection device for fixation of the filter element in the housing as well as for closing the housing, wherein the connection device comprises at least a first connection element and at least a second connection element, wherein, when the filter element is arranged in the housing as intended, the first connection element is connected to the first housing part and the second connection element to the second housing part.

Beneficial embodiments and advantages of the invention result from the additional description and the accompanying drawing figures.

According to an aspect of the invention, a filter element for a fluid, for example, for a liquid, for example, oil or fuel or coolant, is proposed for installation in a housing of a filter system with at least a first housing part and a second housing part, the filter element at least comprising a filter medium body, which comprises at least at a first end face a first end disc, and a connection device for fixation of the filter element in the housing as well as for closing the housing. The connection device comprises at least a first connection element for interaction with the first housing part and at least a second connection element for interaction with the second housing part. In this context, the first and second connection elements are arranged at a circumferentially extending rim element which is connected to the first end disc and which is axially spaced apart from the first end disc.

The proposed filter element comprises a connection device with first and second connection elements for connecting the filter element to the two housing parts. In this context, the connection device is connected to the first end disc of the filter element. The first and second connection elements may be, for example, a combination of inner thread and outer thread. Inner thread and outer thread may comprise different pitches and/or diameters. The first and second connection elements may also be, for example, a bayonet connection in combination with an inner thread or an outer thread.

The connection device which is connected to the first end disc of the filter element serves thus to connect the first housing part to the second housing part by means of the first and second connection elements. In this way, the first housing part may be connected only by means of a matching filter element to the second housing part because the connection elements of the first and of the second housing parts are not compatible with each other. The filter element comprises connection elements for both sides so that the first housing part may be connected indirectly to the second housing part.

The connection device with the first and second connection elements may be embodied together with the first end disc of the filter element as one piece. As an alternative, it is also possible that the connection device is connected detachably to the first end disc, for example, by a latching connection.

According to an embodiment of the filter element, the first end disc may comprise at least one fluid opening in a longitudinal direction for passage of the fluid. The at least one fluid opening may be arranged advantageously in a region radially between the first and second connection elements and the filter medium body so that the filter element may be inserted into filter housings in which the fluid inlet and the fluid outlet are arranged at the same side in the longitudinal direction.

According to an embodiment of the filter element, the at least one fluid opening may be arranged radially outwardly at the first end disc. For example, in this context, the at least one fluid opening may be arranged adjacent to the rim element. For example, the at least one fluid opening may be outwardly closed by the rim element. Advantageously, the filter element may be inserted in filter housings in which the fluid inlet and the fluid outlet are arranged at the same side in the longitudinal direction.

According to an embodiment of the filter element, the first connection element may comprise a first thread and the second connection element a second thread which are configured for interaction with a first counter thread of the first housing part and a second counter thread of the second housing part. In this way, a secure connection between the filter element and the first housing part, on the one hand, and the second housing part, on the other hand, is possible.

According to an embodiment of the filter element, one of the two threads may be embodied as an inner thread and the other one of the two threads as an outer thread. As an alternative, the first and the second threads may be embodied as outer threads. With these alternatives, a secure connection between the filter element and the first housing part, on the one hand, and the second housing part, on the other hand, can be achieved.

According to an embodiment of the filter element, the two threads each may comprise at least one cutout extending in the longitudinal direction.

According to an embodiment of the filter element, the rim element may surround the filter medium body at least in sections. In this context, the first and/or the second thread may surround a portion of the filter medium body in the direction of the longitudinal axis. In this manner, a compact configuration of the filter system in which the filter element is employed may be achieved.

According to an embodiment of the filter element, the rim element may comprise a collar which faces away from the filter medium body in the longitudinal direction. The collar may advantageously serve for receiving at least one of the two connection elements of the connection device.

According to an embodiment of the filter element, the rim element may comprise a radially outwardly facing circumferentially extending projection, wherein the first connection element and the second connection element in the longitudinal direction are arranged on opposite sides of the projection. By means of the projection, the two housing parts may be effectively sealed relative to each other and relative to the filter element.

According to an embodiment of the filter element, the rim element may be connected to at least one end disc by a releasable connection, for example, with at least one latching element. Advantageously, a modular construction of the filter element is possible in this way, which facilitates manufacture and mounting of the filter element.

According to an embodiment of the filter element, the rim element may be formed as one piece together with the at least one end disc. In this way, a compact and inexpensive configuration of the filter element with a connection device integrated in the end disc is possible.

According to a further aspect of the invention, an ion exchanger filter element with a filter element is proposed, wherein a filter medium body of the filter element is embodied as an ion exchanger.

An ion exchanger filter system may be built in which the connection device which is connected to the first end disc of the filter element serves to connect the first housing part of the ion exchanger filter to the second housing part by means of the first and second connection elements. In this way, the first housing part may be connected only by means of a matching filter element to the second housing part because the connection elements of the first and of the second housing parts are not compatible with each other. The filter element comprises connection elements for both sides so that the first housing part may be connected indirectly to the second housing part.

According to a further aspect of the invention, a filter system for a fluid, for example, for a liquid, for example, oil or fuel or coolant, is proposed, with a housing, comprising a first fluid connector and a second fluid connector, and a filter element arranged in the housing. The housing comprises at least a first housing part and a second housing part, which in the direction of a longitudinal axis are sequentially arranged and are connected to each other. The filter element comprises a filter medium body, which comprises at least at a first end face a first end disc, and a connection device for fixation of the filter element in the housing as well as for closing the housing. The connection device comprises at least a first connection element and at least a second connection element. In this context, when the filter element is arranged in the housing as intended, the first connection element is connected to the first housing part and the second connection element to the second housing part.

The proposed filter system comprises a filter element with a connection device with first and second connection elements for connecting the filter element to the two housing parts. In this context, the connection device is connected to the end disc of the filter element. The first and second connection elements may be, for example, a combination of inner thread and outer thread. The inner thread and outer thread may comprise different pitches and/or diameters. The first and second connection elements may be, for example, also a bayonet connection in combination with an inner thread or an outer thread.

The connection device connected to the end disc of the filter element serves thus to connect the first housing part to the second housing part by means of the first and second connection elements. Thus, the first housing part can be connected only by means of a matching filter element to the second housing part because the connection elements of the first and of the second housing parts are not compatible with each other. The filter element comprises connection elements for both sides so that the first housing part may be connected indirectly to the second housing part.

According to an embodiment of the filter system, the first connection element may comprise a first thread and the second connection element a second thread, wherein the first housing part may comprise a first counter thread and the second housing part a second counter thread. In this context, when the filter element is arranged in the housing as intended, the first thread is connected to the first counter thread and the second thread to the second counter thread. In this way, a safe connection between the filter element and the first housing part, on the one hand, and the second housing part, on the other hand, is possible.

According to an embodiment of the filter system, at least an axially and/or radially sealing seal element may be arranged between the connection device and the first housing part and/or the second housing part. In this manner, a reliable sealing action of the housing relative to the environment as well as between raw fluid region and clean fluid region of the filter system may be achieved.

According to an embodiment of the filter system, between the connection device and the first housing part and the second housing part, at least an axially and/or radially sealing seal element may be arranged, wherein at least one seal element forms the sealing action of the first housing part relative to the second housing part and relative to the connection device. In at least one seal element receptacle, all three components are sealed relative to each other by means of solely at least one seal element. Preferably, the at least one seal element seals the inner side of the filter system in relation to the environment. The at least one seal element may be embodied as a shaped seal, for example, in the shape of a half-moon, or a seal produced by being cut from an extruded tube. The at least one seal element may seal axially and/or radially.

In an alternative embodiment of the filter element, the first and the second connection elements are arranged at a circumferentially extending rim element which is connected to a second end disc.

### BRIEF DESCRIPTION OF DRAWINGS

Other advantages result from the following description and accompanying Figures. In the Figures, exemplary embodiments of the invention are illustrated. The Figures and the description disclose numerous features in combination. A person of skill in the art will consider the features expediently also individually and combine them to expedient further combinations.

FIG. 1 shows an isometric illustration of a filter system for a fluid, for example, for a liquid, for example, oil or fuel or coolant, with a filter element according to an embodiment of the invention.

FIG. 2 shows a longitudinal section of the filter system according to FIG. 1.

FIG. 3 shows an isometric illustration of a filter element of the filter system according to FIG. 1.

FIG. 4 shows a plan view of the filter element according to FIG. 3.

FIG. 5 shows a longitudinal section of the filter element according to FIG. 3.

FIG. 6 shows a longitudinal section of a filter system according to a further embodiment of the invention.

FIG. 7 shows an isometric illustration of a filter element of the filter system according to FIG. 6.

FIG. 8 shows a plan view of the filter element according to FIG. 7.

FIG. 9 shows a longitudinal section of the filter element according to FIG. 7.

FIG. 10 shows a longitudinal section of a filter system according to a further embodiment of the invention.

FIG. 11 shows an isometric illustration of a filter element of the filter system according to FIG. 10.

FIG. 12 shows a plan view of the filter element according to FIG. 11.

FIG. 13 shows a longitudinal section of the filter element according to FIG. 11.

FIG. 14 shows a longitudinal section of a filter system according to a further embodiment of the invention.

FIG. 15 shows an isometric illustration of a filter element of the filter system according to FIG. 14.

FIG. 16 shows a plan view of the filter element according to FIG. 15.

FIG. 17 shows a longitudinal section of the filter element according to FIG. 15.

FIG. 18 shows an exploded illustration of a filter system according to a further embodiment of the invention in isometric illustration.

FIG. 19 shows an exploded illustration of the filter system according to FIG. 18 in longitudinal section.

FIG. 20 shows a longitudinal section of a filter system according to FIG. 18.

FIG. 21 shows an isometric illustration of the filter element of a filter system according to FIG. 18.

### DESCRIPTION OF EXEMPLARY EMBODIMENTS

In the Figures, same or same-type components are identified with same reference characters. The Figures show only examples and are not to be understood as limiting.

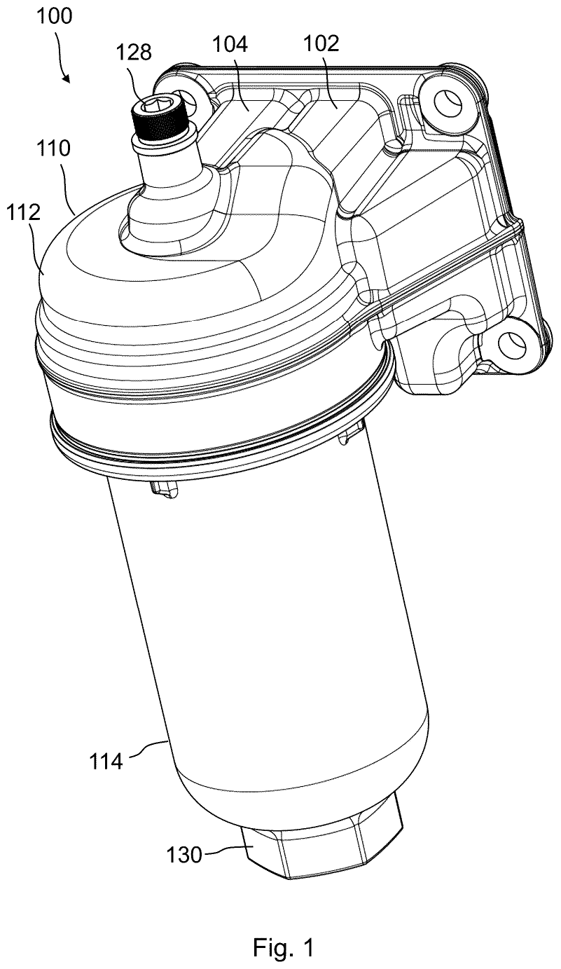

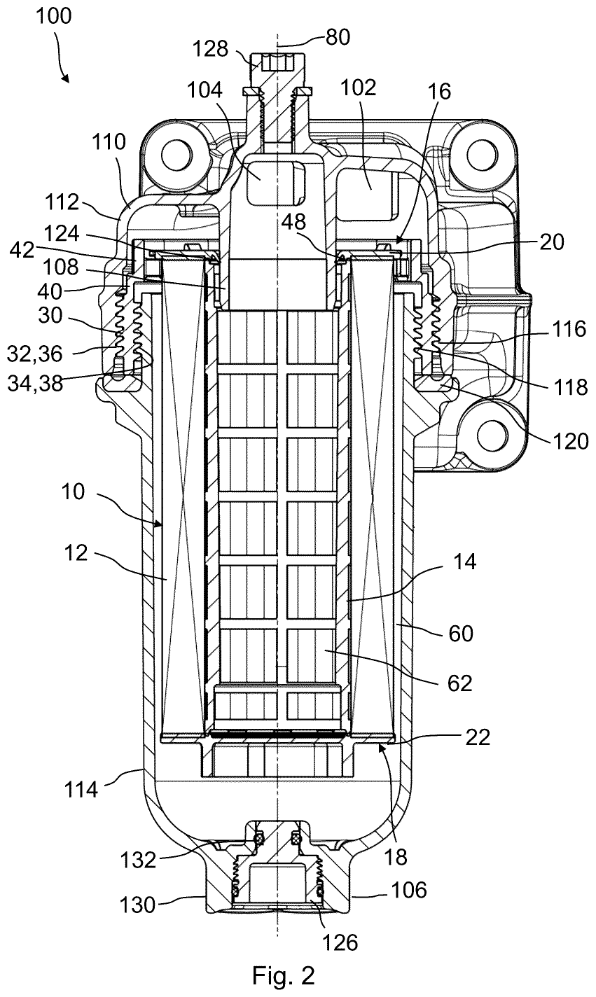

In order to explain the invention, FIG. 1 shows an isometric illustration of the filter system 100 for a fluid, for example, for a liquid, for example, oil or fuel or coolant, with a filter element 10 according to an embodiment of the invention. In FIG. 2, a longitudinal section through the filter system 100 is illustrated.

The filter system 100 comprises a housing 110 with a first fluid connector 102 and a second fluid connector 104 and a filter element 10 arranged in the housing 110. The housing 110 comprises a first housing part 112 and a second housing part 114 which, in direction of a longitudinal axis 80, are sequentially arranged and are connected to each other. First fluid connector 102 and second fluid connector 104 both are arranged at the first housing part 112 in the illustrated embodiment. The first fluid connector 102 represents in this context the fluid inlet and the second fluid connector 104 the fluid outlet.

At the top of the filter system 100 in longitudinal direction 80, the first housing part 112 comprises a venting screw 128. The second housing part 114 comprises a fluid drainage bore 106 which, in operation as intended, is seal-tightly closed with a closure element 126 and a seal element 132, for example, an O-ring. The fluid drainage bore 106 is formed at the outer side of the second housing part 114 as a tool engagement region 130, for example, as a hexagon. In this way, a seized second housing part 114 can be detached from a connection device 30 and thus from the first housing part 112 by turning with a suitable tool

The filter element 10 is arranged in the interior of the housing 110 and comprises a filter medium body 12 which is closed at a first end face 16 by a first end disc 20 and at a second end face 18 by a second end disc 22. A support pipe 14 is arranged in the interior of the filter medium body 12 for reinforcement. The first end disc 20 comprises a central opening 48 for connecting an outlet socket 108 of the first housing part 112 thereto.

The first and second housing parts 112, 114 are seal-tightly connected to each other by the filter element 10. For this purpose, the filter element 10 comprises the connection device 30 for fixation of the filter element 10 in the housing 110 as well as for closing the housing 110.

The connection device 30 comprises a first connection element 32 and a second connection element 34. In this context, when the filter element 10 is arranged in the housing 110 as intended, the first connection element 32 is connected to the first housing part 112 and the second connection element 34 to the second housing part 114.

In the illustrated embodiment, the first connection element 32 comprises a first thread 36 and the second connection element 34 a second thread 38 while the first housing part 112 comprises a first counter thread 116 and the second housing part 114 a second counter thread 118. In this context, when the filter element 10 is arranged in the housing 110 as intended, the first thread 36 is connected to the first counter thread 116 and the second thread 38 to the second counter thread 118.

The first thread 36 is configured as an outer thread while the second thread 38 is configured as an inner thread. The first and second counter threads 116, 118 are embodied complementary thereto as inner thread and as outer thread.

Between the connection device 30 and the first housing part 112 and the second housing part 114, in longitudinal direction 80 at a bottom rim of the first housing part 112 and of the connection device 30, an axially and radially sealing seal element 120 is arranged. The seal element 120 may be designed as a shaped seal, for example, as a half-moon seal. By means of the seal element 120, the two housing parts 112, 114 are sealed in relation to the environment and the filter element 10 is sealed in relation to the inner housing wall of the housing 110. The fluid flows from the first fluid connector 102 provided as fluid inlet across the outer side of the filter medium body 12 provided as raw fluid region 60 through the filter medium body 12, flows through the filter medium body 12 in radial direction from the exterior to the interior to the clean fluid region 62, is filtered thereby, and then flow through the outlet socket 108, which is arranged in the first housing part 112 and is sealed in relation to the filter element 10 in the central opening 48 of the first end disc 20 by the radial seal element 124, for example, an O-ring, to the second fluid connector 104 provided as fluid outlet. The seal element 124, as can be seen in FIG. 2, is arranged at a radially inner side of the central opening 48 of the first end disc 20.

In an alternative embodiment, the flow direction of the fluid can also be in opposite direction.

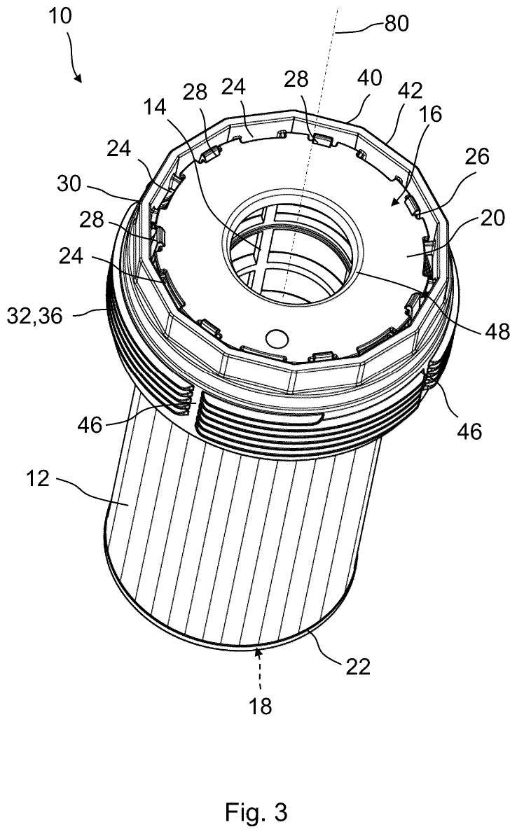

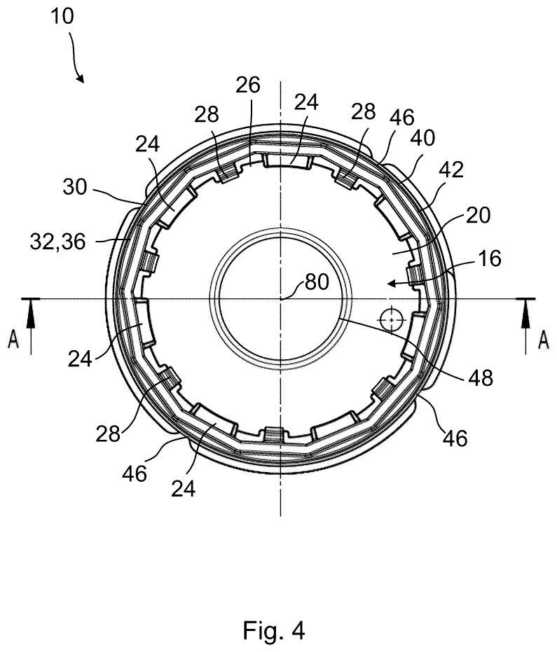

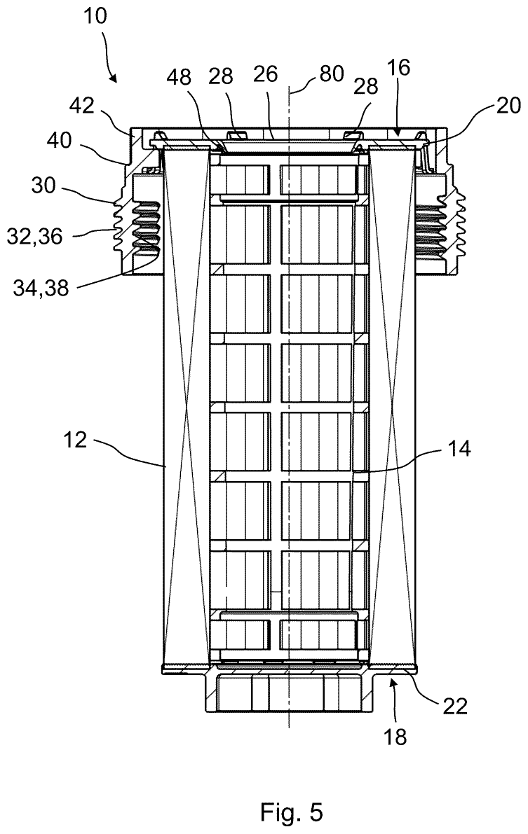

FIG. 3 shows an isometric illustration of the filter element 10 of the filter system 100, while in FIG. 4 a plan view of the filter element 10 and in FIG. 5 a longitudinal section through the filter element 10 is illustrated.

In the illustrations of FIGS. 3 to 5, details of the connection device 30 are shown. The first and second connection elements 32, 34 are arranged at a circumferentially extending rim element 40 which is connected to the first end disc 20. The rim element 40 is axially spaced apart from the first end disc 20.

The rim element 40 surrounds the filter medium body 12 at least in sections. For example, the first and the second threads 36, 38 surround a portion of the filter medium body 12 in the direction of the longitudinal axis 80.

In the illustrated embodiment, the rim element 40 is connected to the first end disc 20 by a releasable connection 26. For this purpose, the rim element 40 comprises a collar 42 which points away from the filter medium body 12 in the longitudinal direction 80 and at which, at its radially inner side, a series of latching elements 28 are arranged. By means of these latching elements 28, the rim element 40 can be clipped to the end disc 20 so that the two engage in a stable connection. The latching elements 28 may be embodied, for example, for providing a snap-on connection to the end disc 20.

The latching elements 28 serve for securing the rim element 40 at the end disc 20 as well as a positioning aide, for positioning along the longitudinal direction 80.

As seen in FIGS. 3 and 4, the first end disc 20 comprises a plurality of fluid openings 24 in the longitudinal direction 80 for passage of the fluid. The fluid openings 24 are arranged radially outwardly at the end disc 20 adjacent to the rim element 40 and are closed outwardly by the rim element 40. Advantageously, the fluid inlet and the fluid outlet can be arranged at the same side in the longitudinal direction 80. The raw fluid thus flows in the housing 110 of the filter system 100 through the fluid openings 24 of the end disc 20 to the radially outer side of the filter medium body 12 and, in this way, passes through the filter medium body 12 in the radial direction from the exterior to the interior and thereby filtered.

As seen in the isometric illustration of FIG. 3, the first thread 36 comprises cutouts 46 which each extend in the longitudinal direction 80 and are distributed about the circumference and through which the raw fluid can flow to the outer side of the filter medium body 12. Similarly arranged cutouts 46 are provided at the radially inwardly positioned second thread 38.

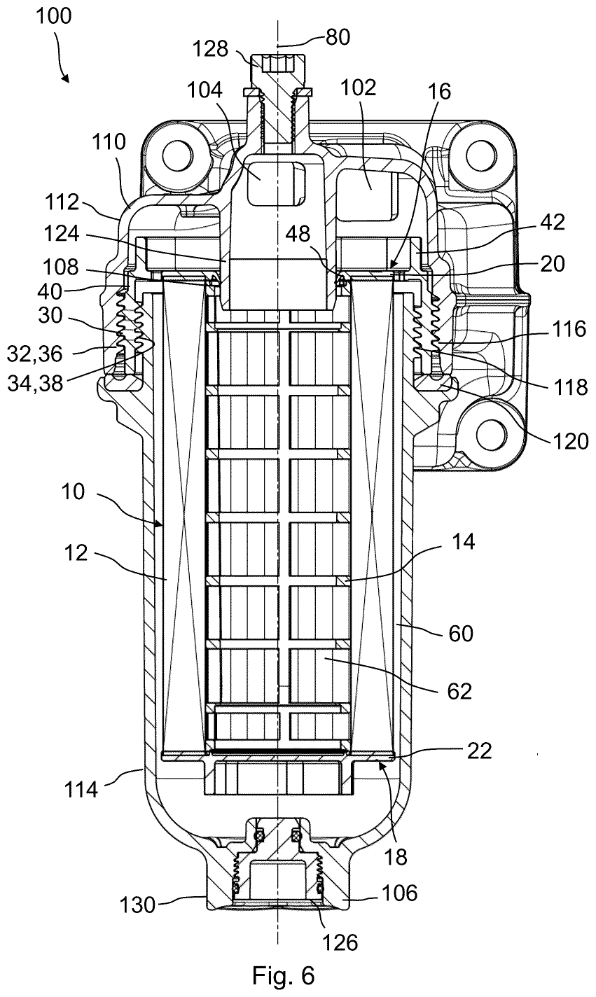

In FIGS. 6 to 21, further embodiments of a filter system 100 with a filter element 10 are illustrated. In order to avoid unnecessary repetitions, only the differences in the embodiments will be explained.

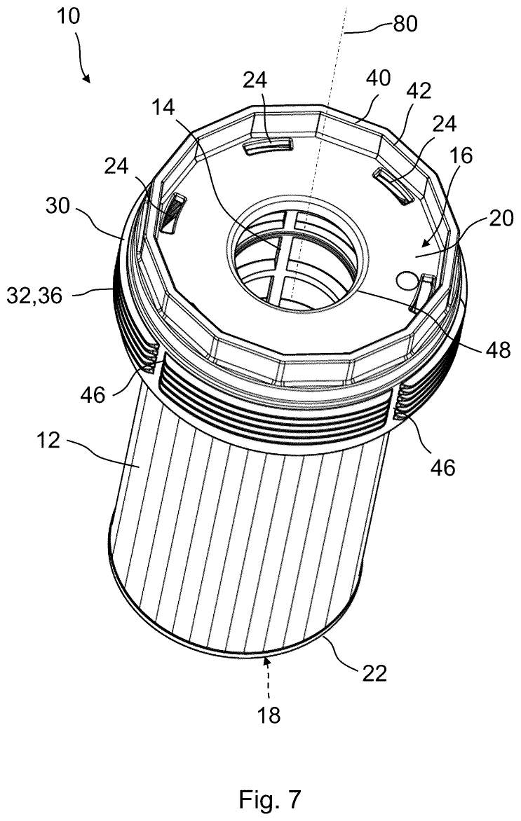

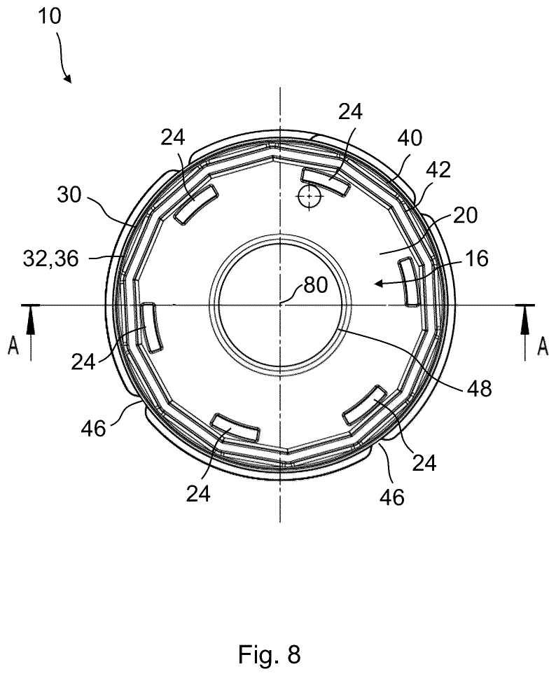

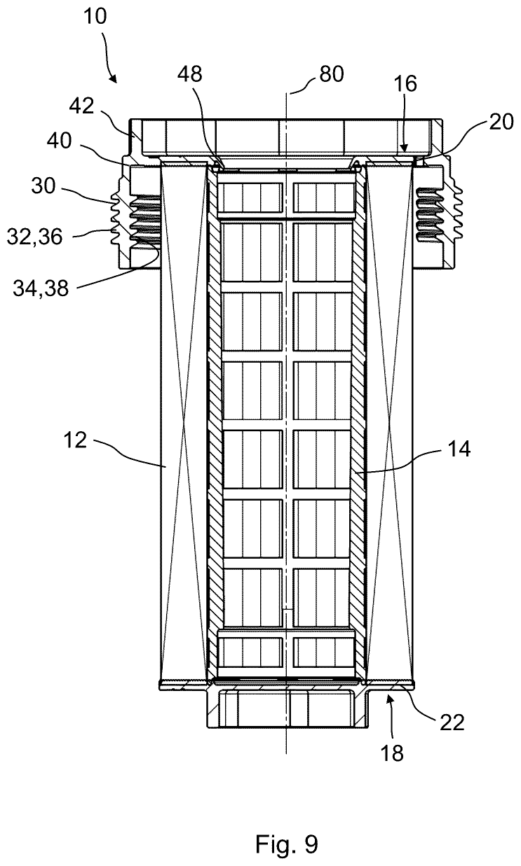

FIG. 6 shows a longitudinal section of a filter system 100 according to a further embodiment of the invention. FIG. 7 shows an isometric illustration of a filter element 10 of the filter system 100 according to FIG. 6, while in FIG. 8 a plan view of the filter element 10 and in FIG. 9 a longitudinal section through the filter element 10 are illustrated.

The embodiment illustrated in FIGS. 6 to 9 is very similar to the embodiment illustrated in FIGS. 1 to 5.

The difference resides in that the collar 42 of the rim element 40 in the longitudinal direction 80 is pulled upwardly farther away from the filter medium body 12. In addition, the rim element 40 is not releasably connected to the first end disc 20 but, for example, welded or glued to the end disc 20. As an alternative, end disc 20 and rim element 40 may also be embodied as one piece.

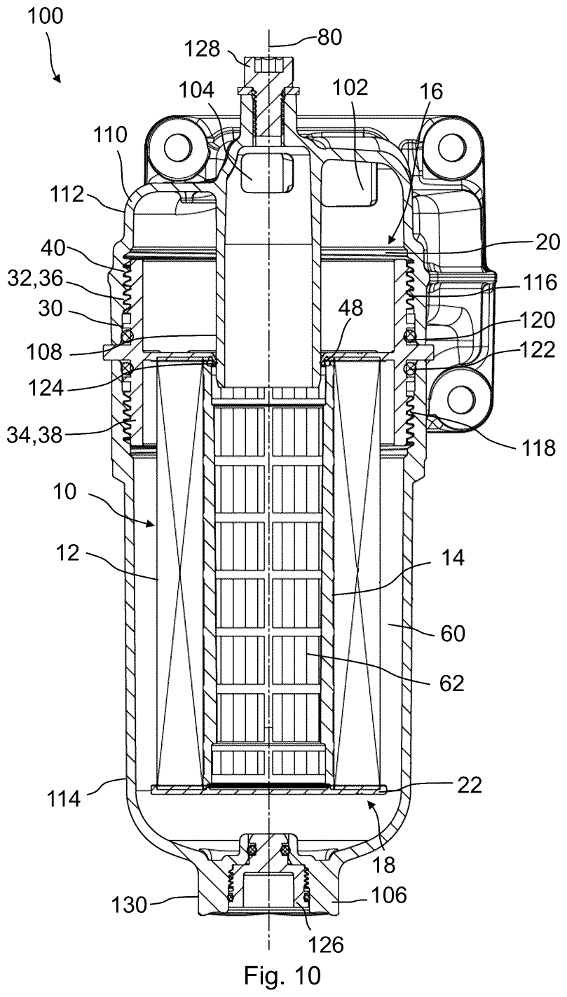

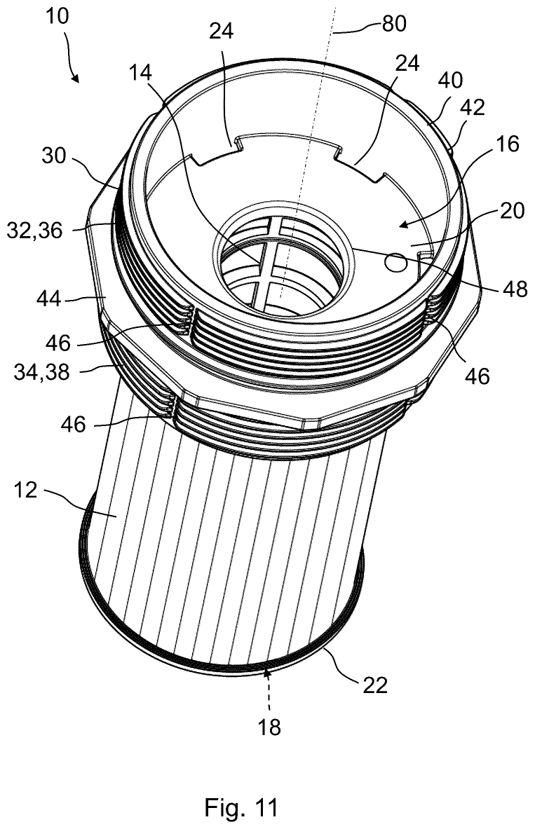

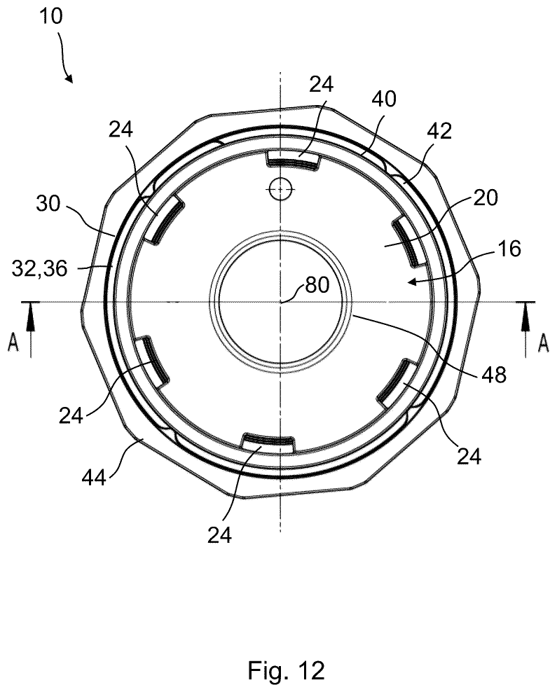

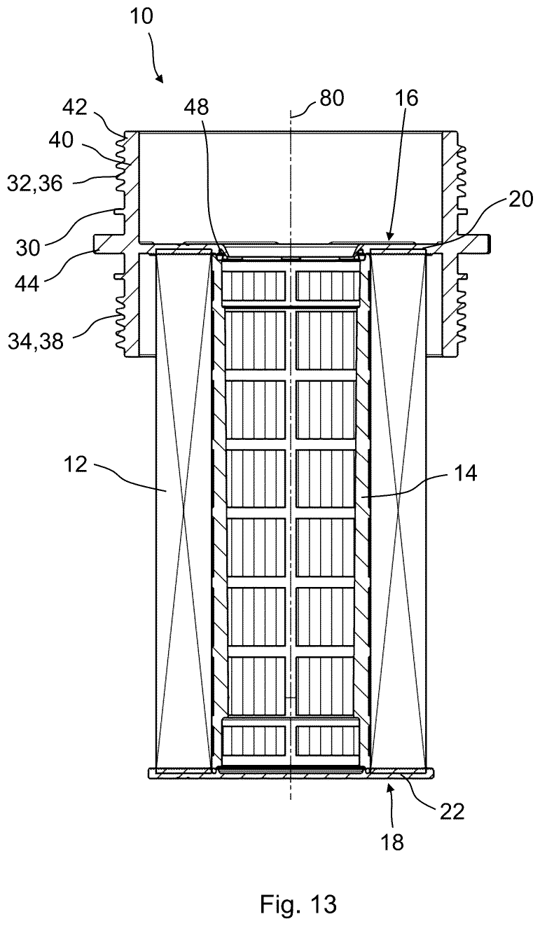

FIG. 10 shows a longitudinal section of a filter system 100 according to a further embodiment of the invention. FIG. 11 shows an isometric illustration of a filter element 10 of the filter system 100 according to FIG. 10 while in FIG. 12 a plan view of the filter element 10 and in FIG. 13 a longitudinal section of the filter element 10 are illustrated.

In this embodiment, the first and the second threads 36, 38 are formed as an outer thread. This is made possible by the collar 42 of the rim element 40 being extended in the longitudinal direction 80. The first and the second counter threads 116, 118 of the first and the second housing parts 112, 114 are therefore formed as inner threads.

The rim element 40 comprises a radially outwardly oriented circumferentially extending projection 44. In this context, the first connection element 32 and the second connection element 34 are arranged on opposite sides of the projection 44 in the longitudinal direction 80.

The first housing part 112 is thus screwed on in the longitudinal direction 80 from the top down toward the projection 44 at the connection device 30, while the second housing part 114 is screwed on in the longitudinal direction 80 from below up toward the projection 44 at the connection device 30. The two housing parts 112, 114 are sealed by seal elements 120, 122, for example, O-rings, in relation to the connection device 30.

In this context, the rim element 40 comprising the connection device 30 is non-detachably connected to the first end disc 20, for example, by welding or gluing.

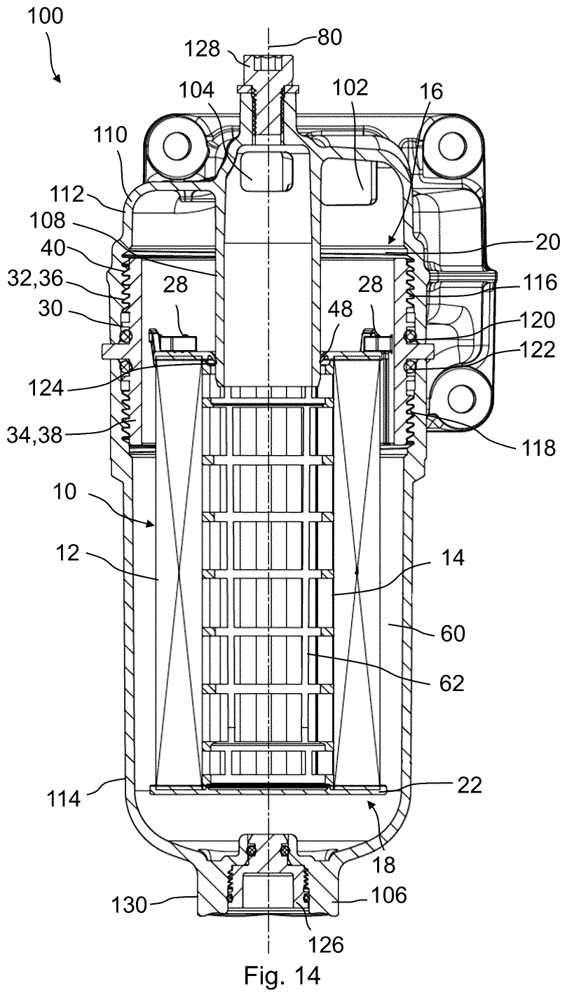

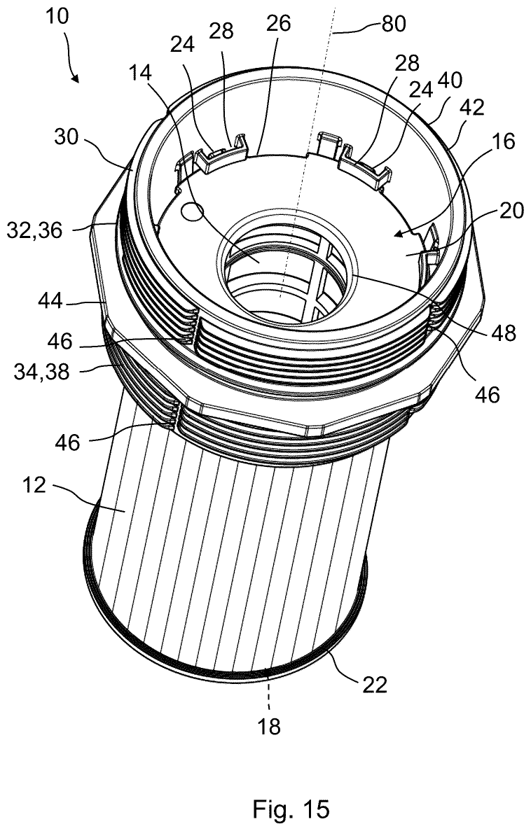

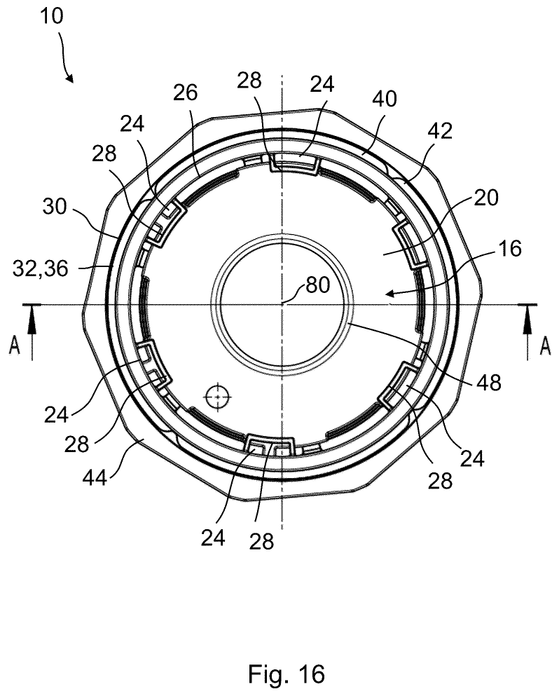

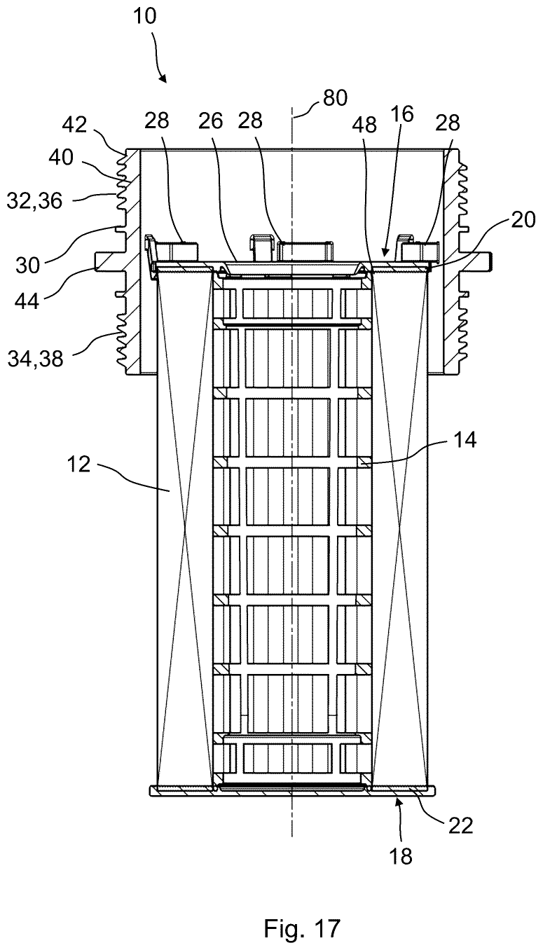

FIG. 14 shows a longitudinal section of a filter system 100 according to a further embodiment of the invention. FIG. 15 shows an isometric illustration of a filter element 10 of the filter system 100, while in FIG. 16 a plan view of the filter element 10 and in FIG. 17 a longitudinal section of the filter element 10 are illustrated.

The embodiment illustrated in FIGS. 14 to 17 is very similar to the embodiment illustrated in FIGS. 10 to 13.

The difference resides in that the rim element 40 in this embodiment is connected by means of a releasable connection 26 to the first end disc 20. For this purpose, the rim element 40 comprises a row of latching elements 28 at the radially inner side of the collar 42 which faces away in the longitudinal direction 80 from the filter medium body 12. By means of these latching elements 28, the rim element 40 can be clipped to the end disc 20 so that the two engage in a stable connection. The latching elements 28 can be embodied, for example, for providing a snap-on connection to the end disc 20.

The latching elements 28 can serve for securing the rim element 40 at the end disc 20 as well as a positioning aide, for positioning along the longitudinal direction 80.

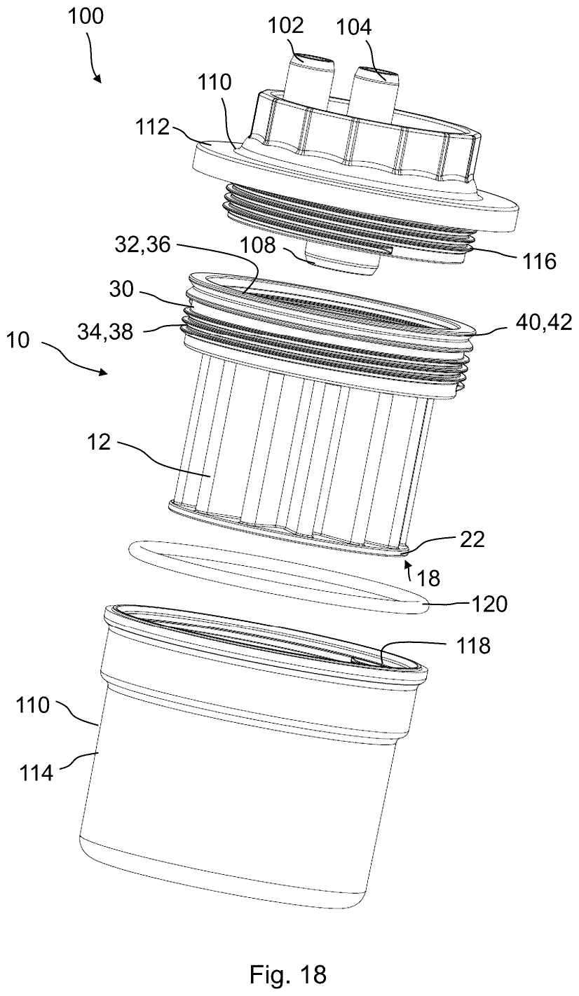

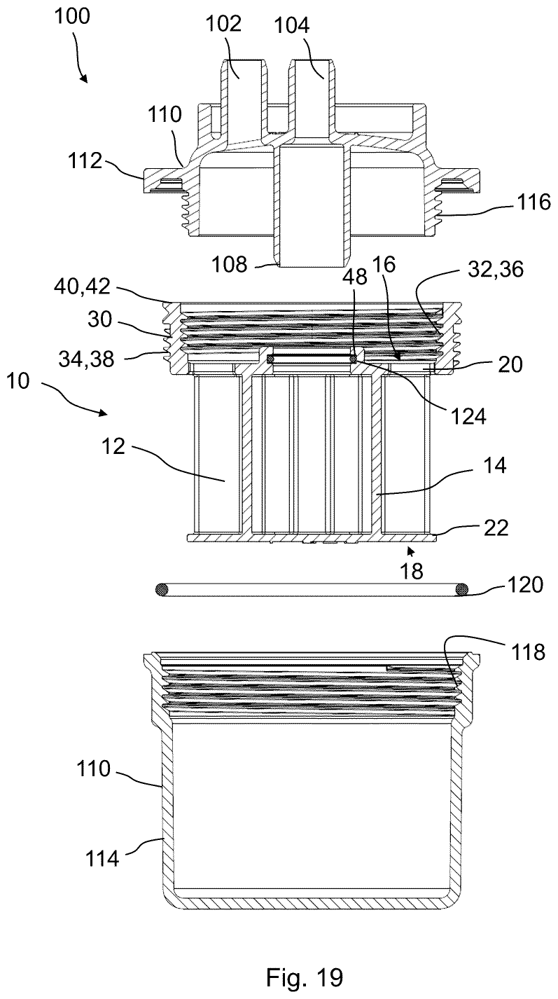

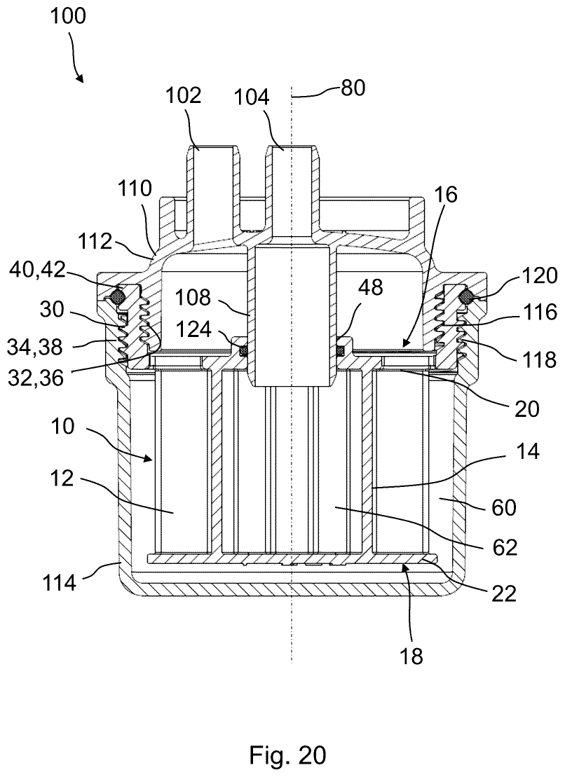

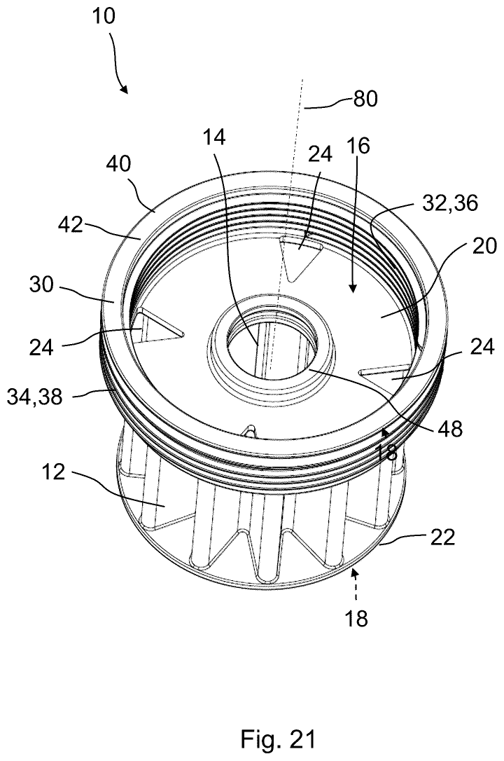

FIG. 18 shows an exploded view of a filter system 100 according to a further embodiment of the invention in isometric illustration, while in FIG. 19 an exploded view of the filter system 100 in longitudinal section is illustrated. FIG. 20 shows a longitudinal section of the filter system 100. In FIG. 21, an isometric illustration of a filter element 10 of the filter system 100 is illustrated.

This embodiment represents a very compact filter system 100 in the longitudinal direction 80. The rim element 40 embodied as a connection device 30 is formed as a collar 42 which faces away from the filter medium body 12 in the longitudinal direction 80.

In this context, the rim element 40 carries an inner thread as a first connection element 32 and an outer thread at its outer side as a second connection element 34. Correspondingly, the first counter thread 116 arranged at the first housing part 112 is an outer thread and the second counter thread 118 arranged at the second housing part 114 is an inner thread.

In the mounted state of the filter system 100 as intended, the connection device 30 at its radially outer side is sealed by a seal element 120, for example, an O-ring, in relation to the inner side of the first housing part 112.

In this embodiment, the rim element 40 is formed as one piece together with the first end disc 20.

As seen in FIG. 21, the first end disc 20 comprises triangularly extending fluid openings 24 for passage of the fluid which are formed to match a cross section of the filter medium body 12. The filter medium body 12 in cross section is embodied in a star shape so that the fluid flowing through the fluid openings 24 reaches the radially outer side of the filter medium body 12.

According to a further embodiment, not illustrated, the filter system 100 may be embodied by an ion exchanger filter system. In this context, the filter medium body 12 of the filter element 10 is embodied as an ion exchanger.

### Reference Characters

10 filter element
12 filter medium body
14 support pipe
16 first end face
18 second end face
20 first end disc
22 second end disc
24 fluid openings
26 releasable connection
28 latching element
30 connection device
32 connection element
34 connection element
36 first thread
38 second thread
40 rim element
42 collar
44 projection
46 cutout
48 central opening
60 raw fluid region
62 clean fluid region
80 longitudinal axis
100 filter system
102 first fluid connector
104 second fluid connector
106 fluid drainage bore
108 outlet socket
110 housing
112 first housing part
114 second housing part
116 first counter thread
118 second counter thread
120 seal element
122 seal element
124 seal element
126 closure element
128 venting screw
130 tool engagement region
132 seal element

What is claimed is:

1. A filter element for installation in a housing of a filter system, the filter element comprising:
a filter medium body comprising a first end disc at a first end face and a second end disc at a second end face;
a connection device configured to fix the filter element in the housing of the filter system and configured to close the housing;
wherein the connection device comprises at least one first connection element configured to interact with a first housing part of the housing and at least one second connection element configured to interact with a second housing part of the housing;
a circumferentially extending rim element connected to the first end disc and axially spaced apart from the first end disc, wherein the at least one first connection element and the at least one second connection element are arranged at the circumferentially extending rim element.

2. The filter element according to claim 1, wherein the first end disc comprises at least one fluid opening for the fluid to pass through, wherein the at least one fluid opening extends in a direction of a longitudinal axis of the filter element.

3. The filter element according to claim 2, wherein the at least one fluid opening is arranged radially outwardly of the longitudinal axis.

4. The filter element according to claim 3, wherein the at least one fluid opening is arranged adjacent to the circumferentially extending rim element.

5. The filter element according to claim 4, wherein the at least one fluid opening is closed off radially outwardly by the circumferentially extending rim element.

6. The filter element according to claim 1, wherein the at least one first connection element comprises a first thread and the at least one second connection element comprises a second thread, wherein the first thread is configured to interact with a first counter thread of the first housing part and the second thread is configured to interact with a second counter thread of the second housing part.

7. The filter element according to claim 6, wherein one of the first thread and the second thread is an inner thread and the other one of the first thread and the second thread is an outer thread.

8. The filter element according to claim 6, wherein the first thread is an outer thread and the second thread is an outer thread.

9. The filter element according to claim 6, wherein the first thread and the second thread each comprise at least one cutout extending in a direction of a longitudinal axis of the filter element.

10. The filter element according to claim 6, wherein the circumferentially extending rim element surrounds the filter medium body at least in sections.

11. The filter element according to claim 10, wherein the first thread and/or the second thread surrounds a portion of the filter medium body in a direction of a longitudinal axis of the filter element.

12. The filter element according to claim 1, wherein the circumferentially extending rim element comprises a collar facing away from the filter medium body in a direction of a longitudinal axis of the filter element.

13. The filter element according to claim 1, wherein the circumferentially extending rim element comprises a radially outwardly oriented circumferentially extending projection, wherein the at least one first connection element and the at least one second connection element are arranged on opposite sides of the radially outwardly oriented circumferentially extending projection in a direction of a longitudinal axis of the filter element.

14. The filter element according to claim 1, wherein the circumferentially extending rim element is connected to the first end disc by a releasable connection.

15. The filter element according to claim 14, wherein the releasable connection comprises at least one latching element.

16. The filter element according to claim 1, wherein the circumferentially extending rim element is formed as one piece together with the first end disc.

17. The filter element according to claim 1, wherein the filter medium body is embodied as an ion exchanger.

18. A filter system for a fluid, the filter system comprising:
a housing having a first fluid connector and a second fluid connector, wherein the housing comprises a first housing part and a second housing part sequentially arranged in a direction of a longitudinal axis of the housing, wherein the first housing part and the second housing part are connected to each other;
a filter element according to claim 1 arranged in the housing;
wherein, when the filter element is arranged in the housing, the at least one first connection element of the connection device of the filter element is connected to the first housing part and the at least one second connection element of the connection device of the filter element is connected to the second housing part.

19. The filter system according to claim 18, wherein the at least one first connection element of the connection device of the filter element comprises a first thread and the at least one second connection element of the connection device of the filter element comprises a second thread, wherein the first housing part comprises a first counter thread and the second housing part comprises a second counter thread, wherein, when the filter element is arranged in the housing, the first thread is connected to the first counter thread and the second thread is connected to the second counter thread.

20. The filter system according to claim 18, further comprising at least one axially and/or radially sealing seal element arranged between the connection device of the filter element and the first housing part and/or the second housing part.
